(19) United States
(12) Patent Application Publication
(10) Pub. No.: US 2005/0103322 A1
(43) Pub. Date: May 19, 2005

(54) Dual flow convection oven

(76) Inventors: Robert L. Smith, Westford, VT (US); David Shangraw, Burlington, VT (US)

Correspondence Address: BRINKS HOFER GILSON & LIONE, P.O. BOX 10395, CHICAGO, IL, 60610, US

(21) Appl. No.: 10/706,979

(22) Filed: Nov. 14, 2003

(51) Int. Cl. A21B 1/00

(52) U.S. Cl. 126/39 C; 126/19 R

(57) ABSTRACT

A dual flow convection oven is described. The oven consists of an inner metal liner spaced away from an insulated housing. Burners are disposed between the liner and the housing so that products of combustion from the burner circulate around the liner heating the same to generate radiant energy within the cooking cavity. A fan is further provided at the back wall disposed between a baffle plate assembly and the back wall of the liner. The baffle plate assembly includes a circular opening coaxially disposed with the fan, and the back wall of the liner has a similar opening for admitting the products of combustion into the fan. Diverter plates are disposed between the baffle plate assembly and the back wall which plates extend only partially around the circumference of the fan. A separate control is provided for the burner assembly to generate either 60,000 or 80,000 BTUs of energy.

### BACKGROUND OF THE INVENTION

This invention is related to a gas fired oven, and in particular to a convection oven which uses a dual flow to mix combustion products with heated air within the oven cavity and to heat the oven cavity to cook food therein.

### DESCRIPTION OF THE PRIOR ART

Convection ovens have been known for many years. They typically cook by introducing hot combustion products into the oven cavity with a fan. For efficient cooking however it is necessary to ensure that there are no hot spots within the oven and that the food to be cooked encounters uniform currents of nearly constant temperature.

The assignee of this invention is also the owner of U.S. Pat. Nos. 4,395,233 and 4,516,012 the disclosures of which are hereby incorporated by reference. These patents describe a dual flow oven wherein heated air from a gas burner is continually admitted into the oven cavity where it is mixed and recirculated with air from within the cavity. The dual flow capability is achieved by the use of a single special purpose fan wherein heated air from the burner is drawn into the back of the fan and air from within the cavity is drawn axially into the front of the fan. The two currents are separated by a plate disposed perpendicular to the axis of the rotation and midway between the front and back edges of the fan blades. The fan utilized in these patents is a squirrel cage type fan disposed in the back wall of the oven cavity. A partition is provided downstream of the fan which has an axial opening for admitting heated air to the fan from within the oven cavity. A similar opening is disposed in the back wall for admitting products of combustion to the fan. In this way then air from within the oven cavity and from the combustion burners enters the fan and is expelled radially behind the partition which acts as a plenum chamber to mix the two air flows and expel them into the oven cavity for circulation around the food to be cooked. Circulated air is also continually expelled through a restricted opening, into a flue.

The dual flow configuration of the above patents provides a more uniform cooking temperate within the oven cavity than would be achieved with a convection fan, alone, to direct products of combustion directly onto the food to be cooked.

The assignee of this invention is also the owner of U.S. Pat. No. 5,497,760 the disclosure of which is hereby incorporated by reference. In that patent, a different type of convection oven and squirrel cage fan is described. The fan in this design is mounted on a side of the oven with in-shot burners vertically mounted behind the fan. In this design a plenum chamber downstream of the fan for mixing the two air streams is not provided and the burners are mounted directly behind the fan so that the heated air from the burners is directly ingested into the fan intake. A concave plate is provided on one face of the fan which is indented axially so that as the fan rotates a low pressure zone will develop in the concavity. This developing pressure differential then facilitates intake of heated air from the burners and a single inlet in the burner wall admits the products of combustion into the intake of the fan. The face of the fan in the oven cavity is open so that as the fan rotates air from within the oven is drawn into the fan to be mixed with products of combustion drawn in through the concavity and the mixture is then expelled radially to return the heated air to the oven cavity. Circulated heated air is similarly expelled into a flue from the oven cavity through a restricted opening in the roof remote from the fan.

The design of the oven in this patent permits a much higher air flow with air changes within the oven cavity in the range of 85-100 per minute. There still remains a need, however, for increasing the fuel efficiency whereby a maximum amount of heat will be extracted from the products of combustion before they are expelled from the oven while maintaining the high air flow characteristics of a convection oven.

In U.S. Pat. No. 4,928,663 there is described a convection oven having a lining spaced away from the outer wall and a heat source in a space between the shell and the liner. The liner then defines the cooking cavity. Hot combustion products enter the oven through a pair of horizontal slots behind the blower wheel. Each slot is covered by a baffle plate spaced away from the wall so that products of combustion must travel around the baffle plate before entering the blower wheel. Air from within the oven is drawn into the blower wheel through another set of baffle plates which are described as either slots or circular. The mixed products are then expelled radially by the blower wheel. This patent does not describe a blower assembly wherein there is a free flow of both combustion products and air from within the oven into the blower wheel for mixture and for recirculation back to the interior of the liner. The slots and baffle plates withdraw energy from the flow of heated air which could have been used to facilitate the cooking process.

Accordingly, there is a need for maximizing the flow of products of combustion into the cooking chamber and for utilizing the maximum heat content thereof for cooking food.

### SUMMARY OF THE INVENTION

It has been discovered that more efficient use of the heat content of the products of combustion can be achieved by circulating the products of combustion around the external surface of the cooking cavity to heat the walls thereof as one source of cooking heat, and by circulating said products of combustion through a squirrel cage type fan in a relatively unobstructed flow for mixing with heated air from within the oven cavity and subsequent expulsion into the oven cavity of the mixture as another source of cooking heat. Convection energy is then supplemented by radiant energy.

The fan used in the device of this invention is a squirrel cage fan with a concave plate disposed substantially perpendicular to the axis of rotation of the fan whereby as the fan rotates an area of low pressure will develop in the concavity to draw air from hot products of combustion into the fan for mixing with heated air from within the oven.

The concave side of the fan is mounted at an unobstructed opening in the back wall of the liner. A baffle and guard assembly is mounted on the front of the fan inside the cooking cavity. This assembly consists of a plate with a central,opening in axial alignment with the fan and preferably a wire basket guard across the opening.

The unique features of the design of this invention include a pair of diverter plates disposed on opposite sides of the opening in the baffle guard assembly extending from that assembly plate towards the back wall of the liner and spaced away from the outer edges of the fan blades. The diverter plates are preferably disposed at about two o'clock and eight o'clock around the circular opening and are preferably about two to three inches square. These diverter plates then facilitate both the mixing of air from the fan, and the directing of it as it is expelled radially from the fan to reenter the cooking cavity. It has been found that these diverter plates supply much needed direction to the currents of air from the fan to further eliminate any hot spots within the oven cooking cavity so that food can be cooked more evenly without providing a plenum mixing chamber.

The oven of this invention preferably has a set of four in-shot burners located between the outer shell and the inner liner horizontally disposed along the lower portion thereof. The inner liner is porcelainized steel so that as the products of combustion circulate in the space between the liner and the shell, the walls thereof are heated. The products of combustion exit the cooking cavity through a restricted outlet into a conventional flue.

The oven of this invention can be mounted on legs, or can be stacked.

Most importantly, however, the oven of this invention can either be operated at 60,000 or 80,000 BTUs by use of an actuator switch easily accessible from the front of the oven so that the cooking rate can be controlled more precisely and fuel used more efficiently. Food then, for example, can be thawed rapidly at one BTU rate and then cooked more slowly at a second BTU rate if desired. The temperature control remains unchanged when the BTU rates are changed.

It is an object of this invention then to provide a convection oven utilizing a dual flow principle to efficiently extract the heat content of products of combustion during the cooking process.

It is another object of this invention to provide a dual flow convection oven wherein the products of combustion are used to heat the walls of an inner liner surrounding the cooking cavity before mixing with heated air within the cavity.

It is still another object of this invention to provide a convection oven having a dual flow squirrel cage type fan wherein the products of combustion from burners are circulated relatively unobstructed into the fan for mixing with air drawn in from the oven cavity and then directed radially to be returned to the cooking cavity.

It is still another object of this invention to provide a convection oven which can be operated selectively at two different BTU rates during the cooking process.

These and others objections will become readily apparent with reference to the drawings and following description.

### BRIEF DESCRIPTION OF THE DRAWINGS

FIG. 1 is a schematic front view of the oven of this invention showing the combustion product pathway.

FIG. 2 is a side view of the schematic of FIG. 1.

FIG. 3 is a view similar to FIG. 1 showing the exit air pathway.

FIG. 4 is a side view of the burner system for the oven of this invention.

FIG. 5 is an isolated view of one side of the baffle and guard assembly mounting plate for the oven fan of this invention.

FIG. 6 is a view similar to FIG. 5 showing the opposite side of the mounting plate of FIG. 5.

FIG. 7 is a perspective view of the squirrel cage fan for the oven of this invention.

FIG. 8 is a side view of the fan of FIG. 7.

FIG. 9 is a front view of the control plate for the oven of this invention.

FIG. 10 is a side view of the control panel for the oven of this invention.

### DETAILED DESCRIPTION OF THE INVENTION

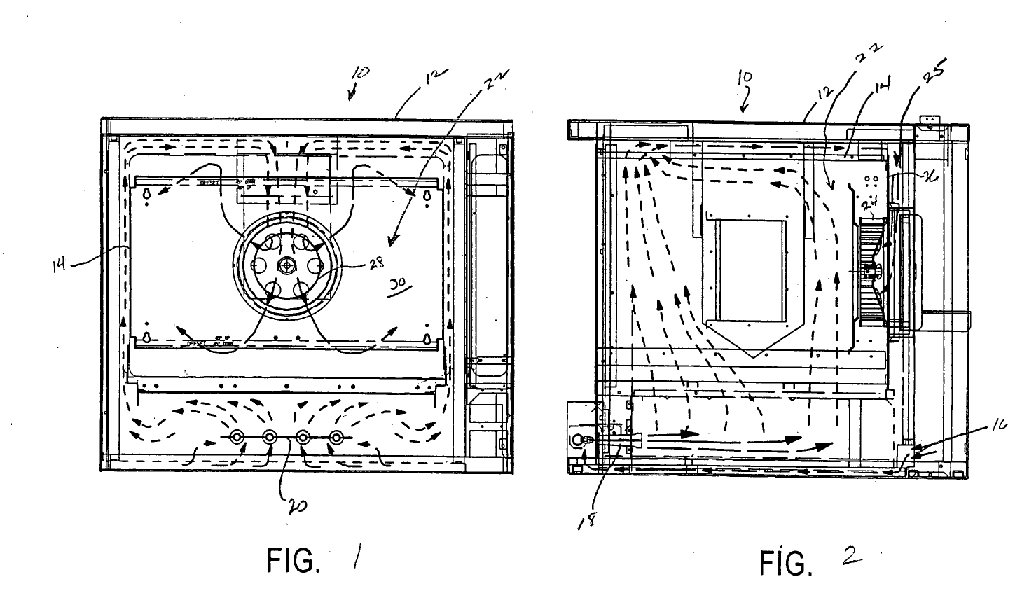

With attention to FIGS. 1 and 2, the oven of this invention 10 includes an outer insulated shell 12, and an inner porcelainized steel liner 14 which is spaced away from the shell 12 to form a pathway.

As shown in FIGS. 1 and 2 the hot combustion gases shown by arrows, travel in this pathway between the insulated shell 12 and the inner liner 14. Outside air is admitted through a port 16 in the bottom of the oven, and is heated by in-shot burners 18 in an assembly 20. The heated products of combustion circulate around the steel liner 14 to heat the same and generate radiant heat within the oven cavity 22. The products of combustion then circulate around the oven liner 14 and enter fan 24 through passage 25 along back wall 26 of said liner 14. Air from within the oven is drawn into the fan 24 through opening 28 in diverter baffle assembly 30 as will be subsequently explained and expelled into the cavity 22.

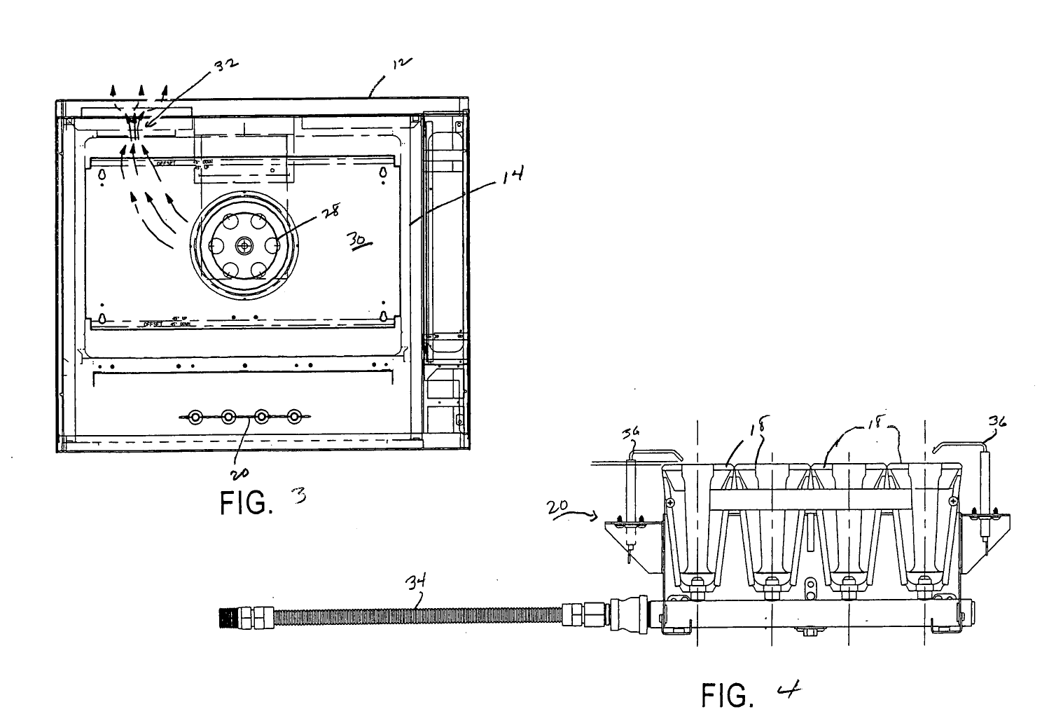

With attention of FIG. 3, air from within the cavity 22 is also expelled through a port 32 into a flue (not shown). The arrows show the flow through the restricted port in this figure. The restricted port 32 then governs the residence time of the heated products of combustion within the cavity for cooking.

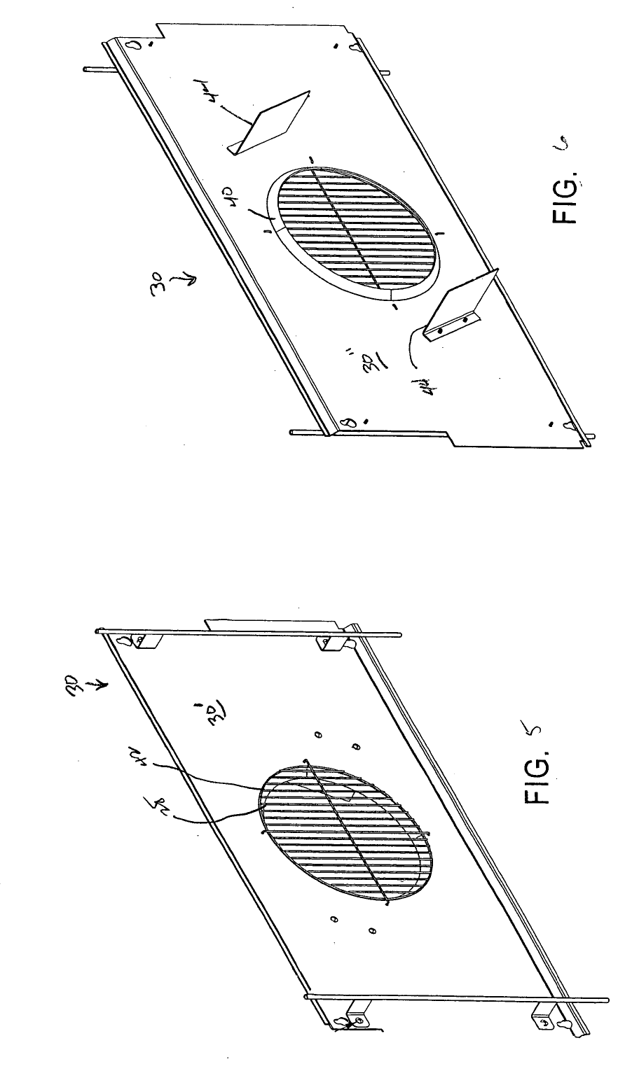

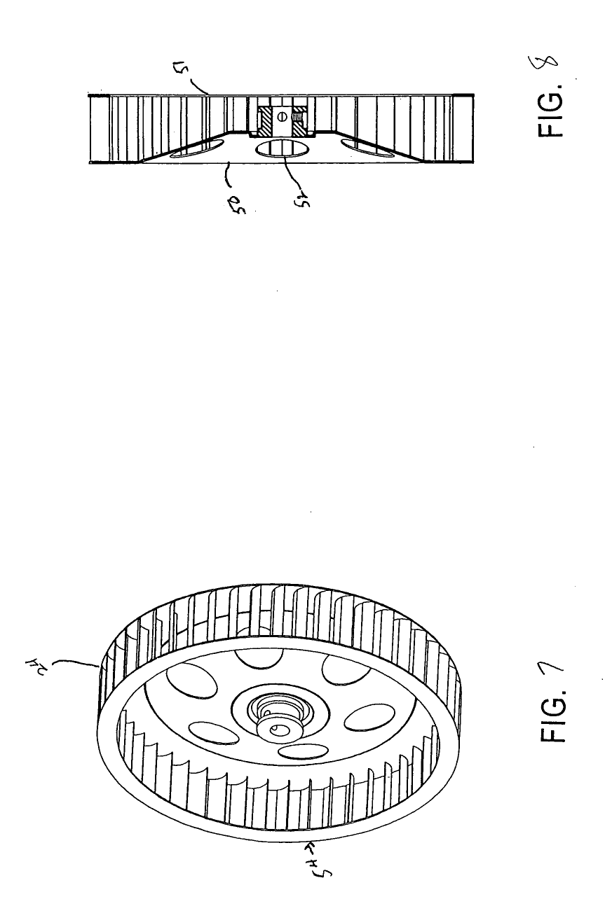

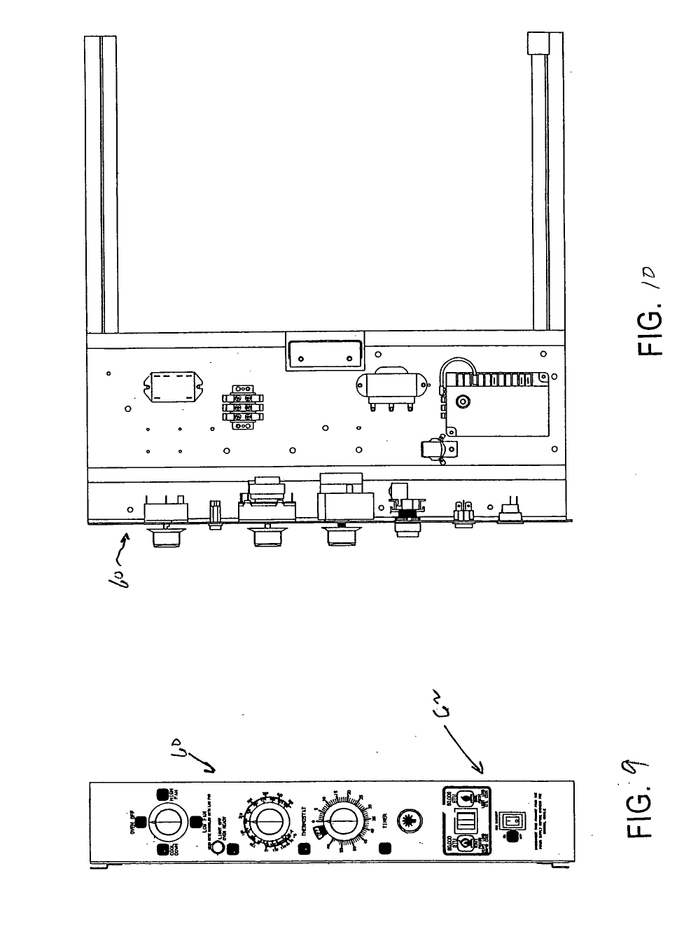

With attention to FIG. 4, the heat source for the oven of this invention preferably is a bank of in-shot burners 18 which are mounted horizontally in the base of the oven of this invention between the insulated shell 12 and the liner 14. The burners are gas operated through a line 34 which is coupled to an external source of gas (not shown). Igniters 36 for burners 18 are provided and function in the conventional fashion.

With attention to FIGS. 5 and 6 the baffle and guard assembly plate 30 has one side 30′ facing into the oven cavity as shown in the FIG. 5 wherein air from within the oven passes through port 28 into the fan 24. The opposite side 30″ shown in FIG. 6 mounts a flange 40 surrounding port 28. Preferably a wire guard 42 is also provided covering the port 28.

Diverter plates 44 are mounted surrounding the fan 24 and affixed to the surface of plate 30. The diverter plates are preferably disposed at about two o'clock and eight o'clock and spaced away from the outer edge of the fan 24 with the plates extending from the baffle guard assembly 30 mounting plate to the back wall 26 of the liner 14. The diverters 44 are preferably about two to three inches across and function to both facilitate mixing without a plenum chamber, and direction of the flow from the fan 24 into the oven cavity 22. The mounting plate 30, and diverters 44 preferably would be constructed of porcelainized steel similar to that used for the liner 14.

With attention to FIGS. 7 and 8 a fan 24 has a concave plate 50 having ports 52 therein. The plate 50 is disposed adjacent the back wall 26 of the liner 14 so that heat products of combustion can circulate downwardly along passage 25 into the low pressure area created by the concave plate 50 as it spins to draw those products of combustion into the fan 24. The opposite side 51 of the fan 24 as shown in FIG. 7 is open to receive heated air from within the oven cavity 22. Side 51 is mounted in alignment with side 30″ of plate 30.

With attention to FIGS. 9 and 10, in the preferred embodiment of this invention solid state electronics are used for the controls, and a typical control plate 60 would be mounted on the front of the oven. As shown in FIG. 9, the typical controls including the fan, thermostat, and timer are present. In addition, however, a burner control 62 is provided whereby the operator can control the burners to either produce heat at 60,000 BTUs, or 80,000 BTUs. This unique feature permits more careful control of the cooking process.

In summary then the convection oven of this invention cooks food by using both radiant heat and convection energy. The radiant heat is supplied as burners circulate products of combustion around a metal liner which defines the cooking cavity. The circulated products of combustion then enter a fan through an unobstructed opening and mix with heated air from within the oven cavity to be expelled by the fan radially into a pair of opposed diverter plates. The diverter plates then supply the necessary direction to the stream of heated air and sufficient turbulence to facilitate mixing without the provision of a plenum chamber.

The diverter plates of this invention are mounted on a baffle plate disposed in front of the fan within the cooking cavity and the plates extend from the baffle plate to the back wall and occupy only a portion of the external circumference of the fan. Preferably the plates are disposed at about two and eight o'clock around the circular inlet opening in the baffle plate.

Finally, in a preferred embodiment of this invention solid state electronics are used for the controls, and the control feature a separate burner control whereby the burners can selectively deliver 60,0000 or 80,000 BTUs with the flick of a switch by an operator.

It will be readily seen by one of ordinary skill in the art that the present invention fulfills all of the objects set forth above. After reading the foregoing specification, one of ordinary skill will be able to effect various changes, substitutions or equivalents and various other aspects of the invention as broadly disclosed herein. It is therefore intended that the protection granted hereon be limited only by the definition contained in the appended claims and equivalents thereof.

1. A dual flow convection oven comprising:
an insulated housing, a heat conducting liner disposed within said housing and spaced away from the walls thereof defining the cooking cavity of said oven, said liner having rear and side walls and a top and a bottom wall, said rear wall having a port there through;
gas burner means disposed between said housing and said liner for expelling hot products of combustion into the space between said liner and housing;
a squirrel cage fan mounted within said liner across the port in said back wall, said fan mounting an internal concave plate on one side adjacent the port in said back wall;
baffle and guard assembly including a plate having a circular opening disposed in front of said fan and said opening being coaxially with said fan and a pair of diverter plates extending from said plate toward said liner back wall covering only a portion of the circumference of said fan whereby heated air passing through the port and through the opening will be mixed and expelled by said fan into the cooking cavity.

2. The oven of claim 1 wherein said diverter plates are disposed at about two and eight o'clock around opening in said plate.

3. The oven of claim 1 wherein a pathway around the space between the rear side top and bottom walls of said liner is defined between said liner and housing whereby when products of combustion circulate through said pathway heating said liner walls to generate radiant heat in said cavity.

4. The oven of claim 3 wherein the pathway adjacent the port in said back wall is unobstructed.

5. The oven of claim 1 wherein the opening in said plate has a mesh guard thereacross.

6. The oven of claim 3 wherein plates are no more than about three inches across.

7. The oven of claim 1 wherein said burner means includes at least one in-shot burner.

8. The oven of claim 7 further comprising:
burner control means for selectively changing the maximum heat energy of said combustion from a first to a second value.

9. The oven of claim 8 wherein said first value is 60,000 BTUs and said second value is 80,000 BTUs.

10. The oven of claim 7 wherein four burners are provided.
